(19) United States
(12) Patent Application Publication
(10) Pub. No.: US 2026/0245228 A1
(43) Pub. Date: Aug. 20, 2026

(54) System and Method for Detecting Materials and Generating A High-Resolution 3D Model

(71) Applicant: University of Connecticut, Farmington Avenue, CT (US)

(72) Inventors: Hongbin Choi, Vernon, CT (US); Pouria Hoveida, Vernon, CT (US); Sina Shahbazmohamadi, Stamford, CT (US); Nicholas M. May, Mansfield Center, CT (US); Pouya Tavousi, Worthington, OH (US); Mohammad Taghi Mohammadi Anaei, Farmington, CT (US); Matthew J. Maniscalco, Farmington, CT (US); Adrian Phoulady, Farmington, CT (US); Parisa Esmaili Mahyari, Farmington, CT (US)

(73) Assignee: University of Connecticut, Farmington, CT (US)

(21) Appl. No.: 19/446,454

(22) Filed: Jan. 12, 2026

Related U.S. Application Data
(60) Provisional application No. 63/743,674, filed on Jan. 10, 2025.

(51) Int. Cl. G06T 7/60; G02B 21/00; G02B 27/14; G02B 27/30

(52) U.S. Cl. CPC G06T 7/60; G02B 21/0024; G02B 27/141; G02B 27/30

(57) ABSTRACT

A system and method for identifying a material and obtaining a three-dimensional (3D) model of a sample is provided. The system includes a laser machining device configured to emit a pulsed laser light onto an object and generate a laser induced plasma. A material characterization device is configured to receive an optical signal from the laser induced plasma and outputting a material signal in response. A 3D measurement device is configured to measure coordinates of a surface of the object. A computation system having a processor is provided. The computation system is operably coupled to the laser machining device, the material characterization device and the 3D measurement device. The computation system is responsive to receive the material signal, identifying a material of the object, and in response to the identifying the material of the object causing a change of at least one parameter of the laser light.

### FIELD OF THE INVENTION

The present disclosure provides a system and method for identifying a material and obtaining high-resolution three-dimensional (3D) models of samples, such as semiconductor materials (e.g., microprocessors, memory, micro-electromechanical systems (MEMS) and other similar components).

### BACKGROUND

Various methods exist that can be used for material characterization. In X-ray diffraction (XRD), which is a nondestructive method, the x-rays are directed at the sample and the scattered rays at specific angles from the sample are collected. The intensity of the peaks diffracted from the sample determines the distribution of the atoms. This method has been used in various applications including the pharmaceutical industry, forensic science, and the microelectronics industry.

Another technique, referred to as X-ray photoelectron spectroscopy (XPS), is a common method for determining the composition of surfaces and interfaces, a solid surface is irradiated with a beam of X-rays and the kinetic energy of electrons emitted from the material is measured. Counting the number of ejected electrons over a range of kinetic energies generates a photoelectron spectrum. The elemental composition and the chemical and electronic state of the atoms are determined from the intensities of the photoelectron peaks. XPS has been employed for surface analysis in various fields such as corrosion, electronics, nanomaterials, biomedicine, and aerospace. XPS may be used to determine the chemical composition and core-shell structure of the iron oxide nanoparticles.

Yet another technique, called energy dispersive X-Ray spectroscopy (EDS) is also used for material identification. The EDS technique is often used with scanning electron microscope (SEM) and it is used to determine the elemental composition of an area of interest which was visually identified and observed using SEM. An X-ray is emitted when the electrons of this area of interest go from an excited state to the ground state. The elemental composition of the area can be determined using the information from these X-rays. A variation of this using various optical light microscopes has been used in combination with the SEM-EDS, for the identification of stone tool residues.

Still another technique, referred to as time-of-flight secondary ion mass spectrometry (TOF-SIMS) is used for analyzing surface information. In this method, a mass spectrum is generated by determining the masses of positive or negative secondary ions. This mass spectrum along with the secondary ion images are used to determine the composition, distribution, and molecular information of surface constituents.

While these techniques provide useful information about the material properties of the sample, most of them require interruption of the machining process, often with a further requirement for transferring the sample to another instrument and waiting for a characterization process and analysis to be completed before the sample can be transferred back to the lasering apparatus and for machining to continue. As a result, using these methods for sample material characterization in combination with laser processing defeats the purpose of real-time machining.

Further, the movement of the sample between the machining process and the analysis device complicates the creation of a three-dimensional model of the object that includes the material characteristics. The creation of this model is done in post-processing and is a time-consuming and costly process.

Accordingly, while existing methods of characterizing materials of an object are suitable for their intended purposes the need for improvement remains, particularly in providing a system and method having the features described herein.

### SUMMARY

The present disclosure provides a system and method for a system. The system includes a laser machining device configured to emit a pulsed laser light onto an object and generate a laser induced plasma. A material characterization device is configured to receive an optical signal from the laser induced plasma and outputting a material signal in response. A three-dimensional (3D) measurement device is configured to measure coordinates of a surface of the object. A computation system having at least one processor is provided. The computation system is operably coupled to the laser machining device, the material characterization device and the 3D measurement device. The computation system is responsive to executable computer instructions to receiving the material signal, identifying a material of the object, and in response to the identifying the material of the object causing a change of at least one parameter of the laser light.

Other aspects of various embodiments will become apparent by consideration of the detailed description and accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram of a system for identifying materials and generating a model of an object according to an embodiment;

FIG. 2A is a perspective view of a system for identifying materials and generating a model of an object according to an embodiment;

FIG. 2B is a partial perspective view of the system of FIG. 2A;

FIG. 3 is a schematic illustration of a portion of the system of FIG. 2A according to an embodiment;

FIG. 4 is a schematic illustration of the system of FIG. 2A according to an embodiment;

FIG. 5 is a block diagram of the system of FIG. 2A;

FIG. 6 is a schematic illustration of an assembly for collecting a LIBS signal according to an embodiment;

FIG. 7 is a partial perspective view of the assembly of FIG. 6 according to an embodiment;

FIG. 8A illustrates a partial perspective view of the acquisition of the LIBS signal according to an embodiment;

FIG. 8B illustrates a partial perspective view of the acquisition of the LIBS signal according to an embodiment;

FIGS. 9A-9D illustrate NIST LIBS database spectral peaks for Aluminum, Silicon, Titanium, and Copper;

FIG. 10 is a flow diagram of a method of operating the system of FIG. 1 and FIG. 2A according to an embodiment;

FIG. 11 is a schematic illustration of an object showing paths and endpoint conditions according to an embodiment;

FIG. 12A is a plan view of a sample processes using the system of FIG. 1 and FIG. 2A according to an embodiment;

FIG. 12B is a plan view of a module of the object of FIG. 12A with material properties included in the model according to an embodiment;

FIGS. 13A-13D illustrate measured LIBS spectra from aluminum, silicon, titanium, and copper via the system of 1 and FIG. 2A, characteristic peaks of corresponding materials are successfully detected in the measured signal and peak locations match NIST LIBS database peak locations shown in FIGS. 9A-9D; and

FIG. 14 is a flow diagram of a method of identifying a material using a LIBS signal according to an embodiment.

The detailed description explains embodiments of the disclosure, together with advantages and features, by way of example with reference to the drawings.

### DETAILED DESCRIPTION

The systems and methods described herein provide, among other things, techniques for identifying materials and generating three-dimensional (3D) models of samples for conducting inspections, failure analysis, and reverse engineering. Samples may include, without limitation, semiconductor devices such as microprocessors, memory, micro-electromechanical systems (MEMS) and other similar components, including, for example, copper substrates, plastics, glass fibers, and the like. The techniques described herein for acquiring images using laser-induced breakdown spectroscopy (LIBS) simultaneously with 3D measurement techniques for micro-scale and nano-scale analysis of samples.

Embodiments of the systems and methods disclosed herein use a top-down tomography technique that includes laser ablation techniques and collects both a LIBS signal and surface coordinate information to generate the high-resolution 3D electronic models of an object or sample. In some embodiments, the systems and methods use femtosecond laser ablation as a method of delayering the sample in combination optical assemblies that acquire a LIBS signal and with optical and confocal microscopy as the imaging technique for rapidly performing 3D analysis of an object or sample. Embodiments of the systems and methods described herein provide a fast and reliable, yet affordable solution for generating high-resolution 3D models of objects or samples that include both geometric representations and material information of the object.

It should be appreciated that the article (e.g. printed circuit board) may be described as being an “object” or a “sample,” these terms may be used interchangeably herein.

Embodiments herein describe the use of a 3D measurement system for acquiring geometric information about the object. This geometric information may include surface coordinate information about the object. One or more embodiments herein may refer to “confocal microscopy,” “confocal laser scanning microscopy (CLSM),” or “laser confocal scanning microscopy (LCSM)” for performing these measurements. Confocal microscopy is an optical imaging technique for increasing optical resolution and contrast of a micrograph. This is accomplished by using a spatial pinhole to block out-of-focus light during image formation.

Capturing multiple two-dimensional images at different depths in a sample enables the reconstruction of three-dimensional structures (a process known as “optical sectioning”) within an object. As opposed to conventional microscopy where light travels as far into the sample as the light can penetrate, a confocal microscope only focuses a smaller beam of light at one narrow depth level at a time. The CLSM achieves a controlled and highly limited depth of field.

Various types of confocal microscopes are commercially available. These include confocal laser scanning microscopes, spinning disc systems, microlens enhanced versions, and programmable array microscopes. These and other types of confocal microscopes may be used with the teachings herein.

As discussed herein, a “confocal height sensor” generally refers to a measuring system that uses confocal principles for distance and thickness measurements. A variety of such devices are known. One non-limiting example includes “confocal DT IFC2465/66” available from Micro-Epsilon America of Raleigh, North Carolina. Generally, the confocal height sensor provides for high precision displacement and distance measurements on diffuse and reflecting surfaces. Very small objects can be detected due to the small measurement spot size. The axial beam path substantially avoids shadowing effects, enabling measurements even in sleeves and recesses. In some embodiments, geometrical features can be measured inside holes and recesses.

It should be appreciated that while embodiments herein refer to the use confocal microscopy for measuring geometric features of the object, this is for example purposes and the claims should not be so limited. In other embodiments, other suitable 3D measurement systems may be used, such as but not limited to: structured light devices, laser line probes, time-of-flight scanners, photogrammetry devices, depth or RGB-D cameras, LIDAR scanners, or a combination of the foregoing for example.

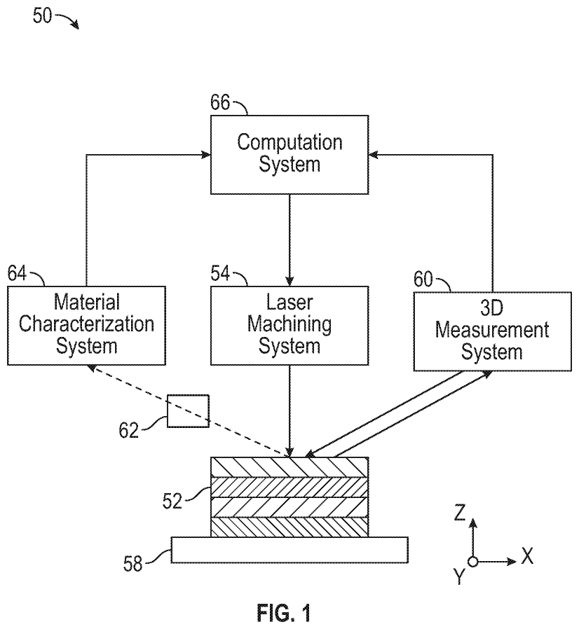

Referring now to FIG. 1, a system 50 is shown for analyzing an object 52, identifying the materials used in the object, the measurement of one or more surfaces in the object, and the generating of an electronic model of the object. The system 50 includes a laser milling system 54 that is configured to use a pulsed laser to ablate material from the object. The ablation is controllable to allow a predetermined layer/thickness of the object 52 to be removed. In an embodiment, the object 52 is positioned on a platen or worktable 58. In an embodiment, at least one of the worktable 58 or the laser milling system 54 is movable in an x-y plane to allow the laser to be moved across the surface of the object 52. In an embodiment, at least one of the worktable 58 or the laser milling system 54 also moves in a z-direction. In still further embodiments, the worktable 58 or the laser milling system 54 may be rotated about one or more of the x, y, z axis. In an embodiment, the movement of the object 52 is measured and stored (e.g. via encoders). The x, y, z measurement data may be combined or fused with distance data from a 3D measurement system 60 to generate 3D coordinates of the surface or layer being ablated.

In an embodiment, the laser milling system includes a 1034 nm, 40 W laser with a 257 pulse width that can produce a range of pulse repetition rates from a single pulse to 50 MHz. In an embodiment, the laser emits a 2.7+/−0.3 mm diameter beam. The beam passes through a beam expander having a fused silica 75 mm aspherical lens and a fused silica 300 mm convex lens to produce an 11 mm beam diameter. The beam is then delivered through a telecentric fused silica F-Theta lens that has an effective focal length of 70 mm to generate a theoretical laser spot size of approximately 8.8 micrometers. In an embodiment, the laser is a femtosecond type laser. In another embodiment, a 1064 nm 30 W nanosecond laser with a 5 ns pulse width was used. This embodiment generated a 9+/−1 mm diameter beam that was focused to 30 micrometers spot size. The laser was pulsed at 30 kHz and a fluence of 13 J/cm\hat{ }2.

In an embodiment, the laser source is configured to generate two pulses separated by 20 nano-seconds with a repetition rate of 30-100 kHz, with a fluence of about 13-20 J/cm\hat{ }2.

In another embodiment, the laser source is configured to emit the laser light with a wavelength of 1035-1064 nm with a power of 30-40 Watts.

In an embodiment, an optical collection system 62 is positioned adjacent the object 52. The optical collection system 62 may include one or more lenses or filters that receive a reflected light or signal from laser induced plasma on the surface of the object 52 (referred to herein as a “LIBS signal”). The optical collection assembly 62 may include a fiber-optic cable that routes the LIBS signal to a material characterization system 64. In an embodiment, the material characterization or optical collection system 62 includes an Echelle spectrometer that disperses the LIBS signal in two orthogonal directions using dispersive elements. The first optical path is dispersed through a prism that separates the incoming light into multiple orders and then through a diffraction grating that separates the overlapping orders along a second optical path. This process creates a ladder of different reflection orders on a photo-sensitive sensor, such as a complementary metal oxide semiconductor (CMOS) array for example. In an embodiment, the CMOS array has an array of 1936×1215 pixels.

The system 50 further includes a 3D measurement system 60. In the exemplary embodiment, the 3D measurement system 60 is a confocal microscopy system. However, this is for example purposes and the 3D measurement system may include structured light devices, laser line probes, time-of-flight scanners, photogrammetry devices, depth or RGB-D cameras, LIDAR scanners, or a combination of the foregoing for example. In an embodiment, the 3D measurement system 60 measures a distance to the surface of the object 52. In an embodiment, a confocal height sensor is used. The distance/height measurement may combined with the aforementioned x, y, z data to generate 3D coordinates of the surface of the object 52.

The material characterization system 64 and the 3D measurement system 60 provide or transmit data/signals to a computation system 66. The computation system 66 includes one or more processors that are responsive to executable computer instructions for performing one or more methods in response to an input from the material characterization system 64 or 3D measurement system 60. In an embodiment, the methods performed by the computation system 66 include the identification of one or more materials of the object, the determining of 3D coordinates of the object, the generating of an electronic model of the object, and the controlling or adjusting of the operation of the laser machining or laser milling system 54. In an embodiment, the LIBS signal is used to determine a material or a material change in the object 52. In response to the identification of the material, the computation system 66 may cause a change in the laser parameters used to ablate the material of the object. The laser parameters may include, but are not limited to, optical power, wavelength of light, the duration of the laser pulse, the duration time between laser pulses, laser spot size and laser fluence.

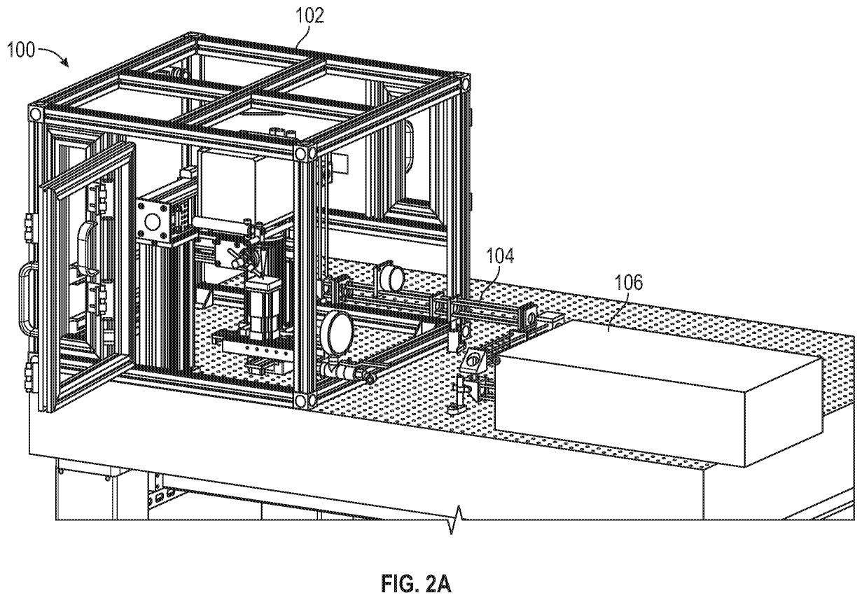

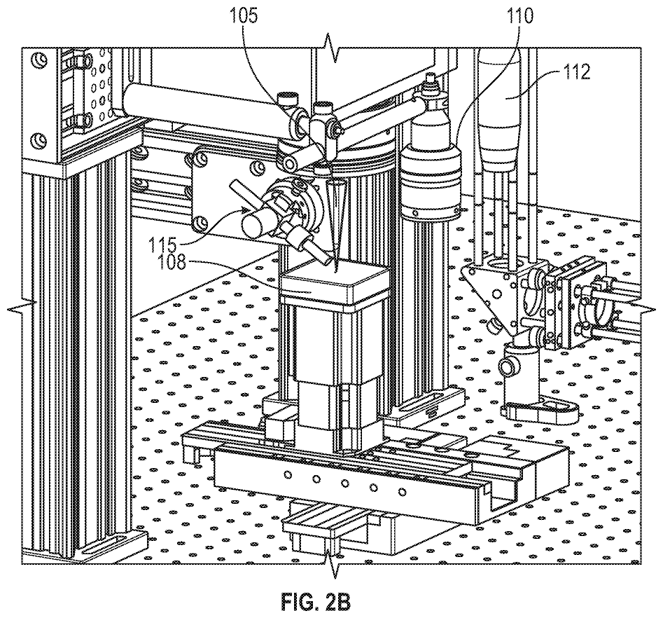

Referring now to FIG. 2A and FIG. 2B an embodiment of a system 100 is configured to mill or delayer an object 116 with a laser, identify materials in the object, and generate a 3D electronic model of the object. The system includes a frame or housing 102 with an optical assembly 104 that routes laser light emitted by a laser source 106 onto a worktable 108. In an embodiment, the worktable 108 includes a vacuum chuck and is movable in an x, y, z direction. Coupled to the housing 102 is a confocal height sensor 110 that is positioned to measure a distance to the surface of the worktable 108. A 3D measurement system, such as a confocal microscopy device 112 is positioned adjacent the worktable 108.

In some implementations, the system 100 is configured to provide fast, clean, high aspect ratio cross-sectioning of samples, such as, microelectronic parts. The system 100 in this example provides high-precision and high-throughput machining for material removal (e.g., for intrusive inspection of electronic components) involving tasks such as sample preparation, delayering, and de-packaging of samples (e.g., micro/nano-scale electronics, components, and the like). The laser source 106 is positioned to emit a controlled laser beam through a sequence of optical devices (e.g., lenses, filters, and/or mirrors) in the optical assembly 104 that deliver the laser beam from the laser source 106 to the laser scan head. The laser scan head controllably projects the laser beam to an object (e.g., a microelectronic device IC) positioned on a top surface or platform of the worktable 108.

In some implementations, the laser source 106 includes a femtosecond pulsed laser. For example, the laser source 106 may include a femtosecond laser system (e.g., a MONACO® femtosecond laser available from Coherent Labs) with 40 W average power, 1035 nm wavelength, and 257 femtosecond pulsed width that can produce a wide range of different pulse repetition rates, from single shots up to 50 MHz. Femtosecond pulsed lasers cause a reduced to zero heat affected zone (HAZ) and, therefore, are well-suited for fine machining of microelectronic parts when throughput is also an important consideration.

In one embodiment, the worktable 108 may be configured as a three degree-of-worktable (e.g., a three degree-of-freedom stage available from Zaber Technologies Inc.). A three degree-of-freedom worktable has sub-micron translational accuracy for highly precise alignment of the to-be-machined surface with the laser beam and precise focusing/defocusing of the laser beam 105. The worktable includes a support surface or platform (where the to-be-machined sample is placed) positioned on top of a z-stage pillar. The z-stage pillar is configured to controllably adjust a position of the sample platform in the z-direction (e.g., up, and down). The z-stage pillar is coupled to a y-stage track that includes an actuation mechanism (e.g., an electric motor) for adjusting a position of the z-stage pillar (and the sample positioned thereon) in the y-direction (e.g., back and forth). Finally, the y-stage track is coupled to an x-stage track that also includes an actuation mechanism (e.g., an electric motor) for adjusting a position of the y-stage track, the z-stage pillar, and the sample positioned thereon in the x-direction (e.g., left, and right). Accordingly, the worktable 108 is configured to adjustably position a object being analyzed on the platform in the x, y, and z directions and relative to the laser scan head and the microscope or confocal imaging system 112.

The worktable 108 also enables a fixed beam laser ablation scheme and is further synchronized with the laser scan head through the system controller (e.g. computation system 66, FIG. 1). The system controller provides for implementing hybrid machining in which concurrent movement of the worktable 108 and the laser scan head further increase the scanning rate of the system. The laser scan head may be coupled to a support arm track configured to adjust a position of the laser scan head in the x-direction. The laser scan head also includes one or more controllable mirrors, lenses, and/or other optical devices configured for controllably lasering and focusing the laser beam (from the laser source 106) on the machining plane (i.e., a target plane corresponding to the sample placed on the sample surface of the worktable 108). In some implementations, the laser scan head includes a galvo scanner and a Q-optic F-O lens (e.g., a BASICUBE® 10 available from SCANLAB GmbH).

In some implementations, the system 100 may also include an acousto-optic modulator (AOM) integrated, for example, into the laser scan head or the laser source 106. The AOM is configured to shutter the laser beam rapidly and controllably for enabling the clean movement of the beam from one location to another without damaging the surface. The AOM is used to start and finish the machining process and to enable jumping from one area of the sample to another. In some implementations, the response time of the AOM is faster than 50 ns.

The system 100 also includes a confocal height sensor 110 (e.g., a confocal displacement sensor available from Keyence Corporation) positioned adjacent to (or coupled to) the laser scan head and positioned with a downward facing field of view (e.g., aimed at the sample surface of the worktable 108 from above). In some implementations, because the confocal height sensor 110 is coupled to the laser scan head, the position of the confocal height sensor 110 relative to the laser scan head is known. The confocal height sensor 110 is configured to acquire height data of the surface of the sample positioned on the sample surface of the worktable 108. In some embodiments, this height data may then be used as feedback information for tuning or adjusting the laser machining parameters and positioning the object being analyzed. In some embodiments, the height data is used for the adjustment of the height of the object relative to the laser scan head to provide a level of in-focus lasering.

In an embodiment, the confocal height sensor 110 utilizes laser confocal technology for height measurement where the light emitted from the laser source 106 is concentrated onto the sample surface via the confocal optical system. The concentrated light reflects off the surface of the object and returns to the photoreceptor through the same light path. In some implementations, a pinhole is placed in the path to the photoreceptor to receive the light and reduces the risk of light other than what passes through the focal point of the objective lens can reach the photoreceptor.

In an embodiment, the system 100 optionally includes a CO₂ nozzle 115 coupled to housing 102 by a nozzle extension arm. In an embodiment, the nozzle extension arm is configured to controllably adjust a position of the CO₂ nozzle 115 in the y-direction by extending and retracting the nozzle extension arm. The nozzle extension arm may also be configured to controllably adjust a position of the CO₂ nozzle 115 in the x-direction by moving the nozzle extension arm along a track of a support arm. In some implementations, the CO₂ nozzle 115 is configured to deliver a CO₂ gas to the machining area by controllable targeting of the CO₂ nozzle 115. As described in further detail below, in some implementations, the system 100 may be configured to cause the CO₂ nozzle 115 to follow the same scan pattern as the laser beam. A relatively large spot size of the CO₂ nozzle 115 and the corresponding injection system allows for compensating the lower accuracy of the 2D movement system of the CO₂ nozzle 115 for achieving higher speeds.

It should be appreciated that when performing laser machining using a femtosecond laser pulse width, the particle size of material removed from the sample during the machining process can range from nanometer-scale to small micrometer-scale. This removed material in many cases redeposits itself onto the surface of the sample. This redeposition can then interfere with future processing of the sample and can cause many complications including, for example, slowed rate of material removal, limits in depth due to the aspect ratio of the processed area, and difficulty in developing optimized laser and scanning parameters used in the process. In some implementations, air guns (e.g., a nozzle emitting pressurized air) can be used to blow the debris from the surface. However, air guns require particle drag to remove the redeposited particles and, if the size of the particle is less than approximately 5 microns, there is not enough drag force to remove this particle from the surface.

Accordingly, in some embodiments, a CO₂ delivery system associated with the CO₂ nozzle 114 is configured to convert CO₂ gas to three phases to benefit from features of each phase. CO₂ applied to the sample in the liquid phase eliminates hydrocarbon as it is a good solvent. CO₂ applied to the sample in the gas phase can be used to blow debris from the surfaces of the sample. And, CO₂ in the solid phase (i.e., CO₂ “snow”) can be controllably applied to the sample surface to remove particle debris generated by the laser machining process that are connected to the sample surfaces by Van der Waal forces. Accordingly, the use of the CO2 delivery system in tandem with the laser processing in the system 100 provides: (1) enhanced wall quality in the machined cross-sections, (2) improved surface quality in terms of surface roughness, (3) enhanced machined depth, (4) reduced collateral damage (e.g., a reduced or eliminated HAZ), and (5) substantially less permanent (e.g., Van der Waal-bonded) debris/particulates.

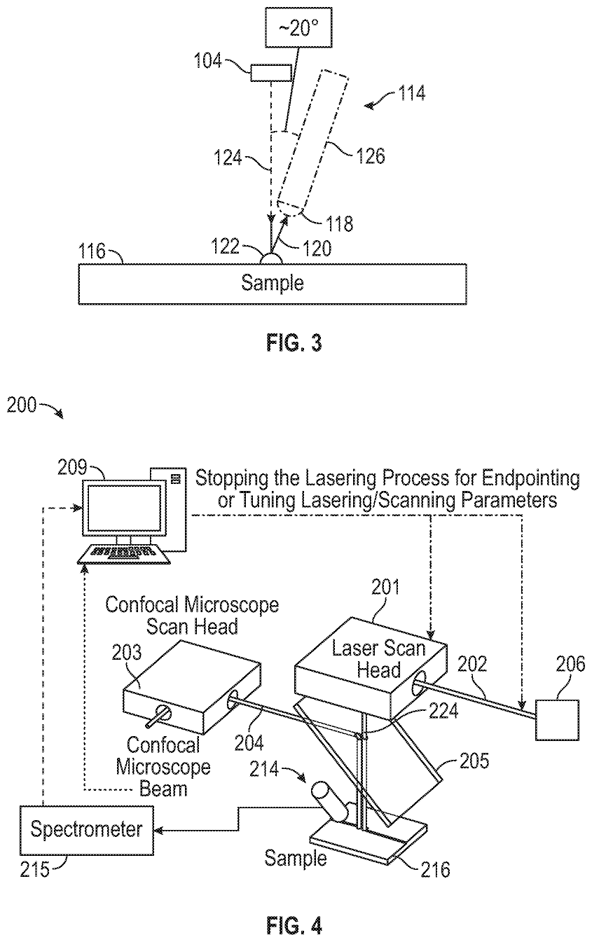

As shown in FIG. 3, an optical collection assembly 114 is positioned adjacent the top surface of the object 116 being analyzed. The optical collection system 114 may include a collimating lens 118 that receives light 120 emitted from laser-induced plasma 122 when the laser light 124 is emitted from the optical assembly 104 onto the object 116. The collimating lens 118 directs the received light (i.e. the LIBS signal) into a fiber optical cable 126. As discussed above with reference to FIG. 1, the LIBS signal is transferred to the material characterization system which generates a spectra plot that is used to identify the material of the laser-induced plasma 122. In an embodiment, the optical collection system 114 is positioned on an angle to the object 116. In an embodiment, the angle is about 20 degrees.

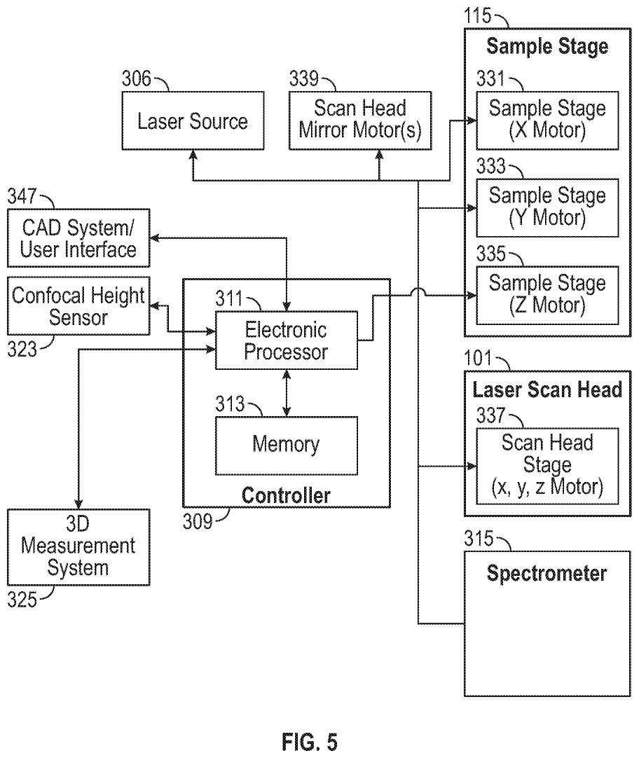

Referring now to FIG. 4, another embodiment of a system 200 is shown having a laser scan head 201 and a microscope scan head 203. The laser scan head 201 receives a femtosecond-pulsed laser beam 202 from a laser source 206 and controllably directs the laser beam 224 towards a surface of the object 216. The laser scan head 201 is configured to scan the laser beam 224 across the surface of the object 216 to perform a milling/ablation of the object 216. Some of the light 204 reflected from the surface of the object 216 during the milling operation is directed by a dichromic mirror 205 towards the microscope scan head 103. In this embodiment, the dichromic mirror 205 is configured to allow the laser beam 224 to pass through in the direction from the laser scan head towards the object 216 while reflecting light 204 that is traveling in the direction from the sample towards the laser scan head 201. The microscope scan head 203 captures and directs the captured light from the surface of the object 216 to a 3D measurement system (e.g., confocal microscope, electron microscope, and the like) configured to capture and record image data of the surface of the object 216. The microscope scan head 203 is configured to move relative to the object 216 so that the field of view of the 3D measurement system follows the laser beam 204 as the laser scan head 201 moves the projected laser beam 224 across the surface of the object 216. It should be appreciated that when a different type of measurement technique is used, such as structured light scanning for example, the dichromic mirror 205 may be used to reflect light from the measurement system onto the object 216. The system 200 is controlled by a system controller 209 as shown in FIG. 5 and further described herein.

Positioned adjacent the object 216 is an optical collection system 214. The optical collection system 214 may be the same or similar to optical collection system 114. The optical collection system 214 receives light from the laser-induced plasma on the surface of the object 216 and transmits the light (i.e. the LIBS signal) to a spectrometer 215 which generates a spectra of the LIBS signal. The spectra is transmitted to the system controller 209 for identification of the material. It should be appreciated that the timing of the pulsed laser beam 202, 224 may be adjusted to accommodate the time to acquire the LIBS signal, process the spectra and identify the material. In an embodiment, the system 200 may integrate a pulse delay generator into the laser source to synchronize the laser source with the LIBS analysis components and avoid overshooting endpoints.

FIG. 5 illustrates an embodiment of a system controller 309. It should be appreciated that the computation system 66 or system controller 209 may be the same or similar to system controller 309. The system controller 309 includes an electronic processor 311 and a non-transitory computer-readable memory 313. The memory 313 stores data and computer-executable instructions that are accessed and executed by the electronic processor 311 to provide the functionality of the system controller 309 (including, for example, the functionality described herein). The system controller 309 is communicatively coupled to the worktable 108 having a plurality of movement stages with one or more motors and is configured to generate and transmit control signals to the movement stages to control movement of the object 216 relative to the confocal microscope scan head 203 and the laser scan head 201. The system controller 309 is also communicatively coupled to the laser source 206 and is configured to generate and transmit control signals to the laser source 206 to define and adjust parameters of the laser beam emitted by the laser source 206. Similarly, the system controller 309 is communicatively coupled to the 3D measurement system and is configured to receive image/measurement data of the surface of the object 216 from the 3D measurement system 325.

The system controller 309 is communicatively coupled to a plurality of electric motors that facilitate the controlled movement of the worktable 108, the laser scan head 201, and the CO₂ nozzle 115. For example, the system controller 309 generates and transmits control signals to an x-motor 331, a y-motor 333, and a z-motor 335 of the worktable 108 to control positioning of the object 216 positioned on the sample surface of the worktable 108 in 3D space. The system controller 309 also generates and transmits control signals to an x-stage motor 337 for the laser scan head 201 to controllably adjust a position of the laser scan head 201 in the x-direction and to one or more additional electric motors 339 that control the positioning/orientation of the mirror(s) of the laser scan head 201 for controllably scanning the laser beam 224 on the surface of the object 216. Finally, the system controller 309 optionally generates and transmits control signals to an x-motor and a y-motor to control positioning of the CO₂ nozzle 115 in a two-dimensional plane above the worktable 108.

In this way, the system controller 309 can controllably synchronize movement of the CO₂ nozzle 115 and the projected laser beam relative to the object 216 to cause the CO₂ nozzle 115 to emit CO₂ along the same path as the laser machining. The system controller 309 is also communicatively coupled to the laser source 306 and the actuators/valves of the CO₂ system. The system controller 309 is configured to generate and transmit control signals to regulate the laser beam 202 and the CO₂ applied to the object 216. Accordingly, the system controller 309 is configured to controllably synchronize the location of the laser spot on the surface of the object 216 in tandem with the CO₂ jet spot and applies an appropriate time delay between the two to avoid interaction of the laser beam 202 with the CO₂ spot. In some implementations, the system controller 309 is also configured to generate and transmit control signals to the laser source 306 to cause the laser source 306 to adjust various parameters of the laser beam 202 (e.g., on/off, frequency, power/amplitude, pulse width) and to generate and transmit control signals to the actuators and valves of the CO₂ system to controllably adjust various parameters of the emitted CO₂ (e.g., on/off, pressure of CO₂ jet, state of CO₂ jet, etc.). The system controller 309 is also communicatively coupled to the confocal height sensor 323 and configured to receive a signal output from the confocal height sensor 323. The signal output from the confocal height sensor 323 is indicative of one or more surface heights of the object 216 relative to a coordinate frame used by the system 100, 200. The controller 309 can utilize the height data from the confocal height sensor 323 to adjust the operation of the system 100, 200 (e.g., by raising/lowering the platform of the worktable 108 and adjusting an angle of the laser scan head 201, etc.).

The system controller 309 is also communicatively coupled to 3D measurement system 325 and configured to receive a signal output from the 3D measurement system 325 such as a two-dimensional image of a surface of the object. The 3D measurement system 325 may comprise a confocal microscope, an electron microscope, an ion microscope, a structured light scanner, laser line probes, time-of-flight scanners, photogrammetry devices, depth or RGB-D cameras, LIDAR scanners, or a combination of the foregoing for example. In an embodiment, the system controller 309 is configured to receive a 2D image of a first surface of the 216 from the 3D measurement system 325 and a 2D height map of the first surface of the object 216 from the 3D measurement system. The system controller 309 is configured to process the two images from the 3D measurement system 325 to generate a 3D surface image of the first surface of the object 216.

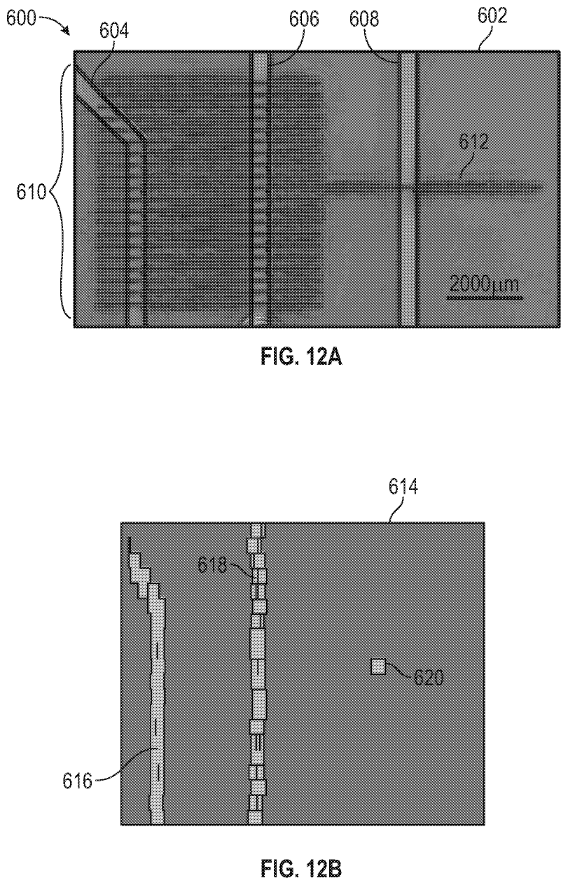

In one embodiment, the 3D measurement system 325 is a confocal microscope, the system controller 309 is configured to receive a 2D optical image (FIG. 12A) from the confocal microscope/microscope imaging system and a confocal image from the confocal microscope/microscope imaging system that provides surface height information (e.g., a 2D surface height map) of the same imaged area. The system controller 309 is configured to process the two images from the confocal microscope/microscope imaging system to generate a 3D surface image. In some implementations, the system controller 309 is configured to overlay the optical image acquired by the confocal microscope/microscope imaging system 325 onto the confocal height image acquired by the confocal microscope/microscope imaging system 325 for each layer of the object 216 to generate the 3D image of the surface. In some implementations, the RGB information from the 2D optical image acquired by the confocal microscope/microscope imaging system 325 is combined with the 2D height information from the confocal image acquired by the confocal microscope/microscope imaging system 325 to generate a 3D image for each surface of the sample. The resulting compound image, for each surface, is registered in a universal coordinate system. Fiducial marks created on the object 216 aid in establishing the global or universal coordinate system, by correcting for translation, rotation, and tilting of the object 216 that occurs across different images. A mask may be generated, based on the 2D height map, that prescribes the upcoming lasering pattern for the surface of the object 216. In an embodiment, a mask is generated for each lasering step.

Each laser step removes all or a portion of the sample to expose a new surface of the sample. The new surface may be referred to herein as a first surface, a second surface, a third surface, etc. where the first surface, the second surface, and the third surface are different. For example, the first surface may be a top surface of the sample prior to any lasering steps being conducted. As another example, the second surface is the exposed surface of the sample after a first lasering step is conducted on the sample. As a further example, the third surface is the exposed surface of the sample after a second lasering step is conducted on the sample.

It should be appreciated that synchronously with the acquiring of the 3D surface information, the LIBS signal is being generated and spectra is created by the spectrometer 315 and acquired to determine the material(s) of the object. As such, the 3D electronic model is generated with both the geometric features of the object and the material information.

The system controller 309 is also communicatively coupled to a user interface 347 including a display device and one or more user input devices (e.g., a keyboard, mouse, etc.).

The user interface 347 is configured to receive various operating instructions and parameters from a user. In some implementations, the user interface 347 includes a computer-assisted design system that is configured to receive inputs from a user defining parameters of the machining to be performed by the system 100, 200 (e.g., position, size, pattern, depth, etc.). In some implementations, the user interface 347 is also configured to receive user instructions defining the state of matter of the CO₂ to be used during the machining process. In some implementations, the user interface 347 allows the user to define different states of matter for the CO₂ to be used at different stages of the machining process (e.g., the machining process can be user-defined to emit CO₂ in gas form to “blow” debris at one step and to emit solid CO₂ snow at another step to remove debris attracted to the sample by, for example Van der Waals force).

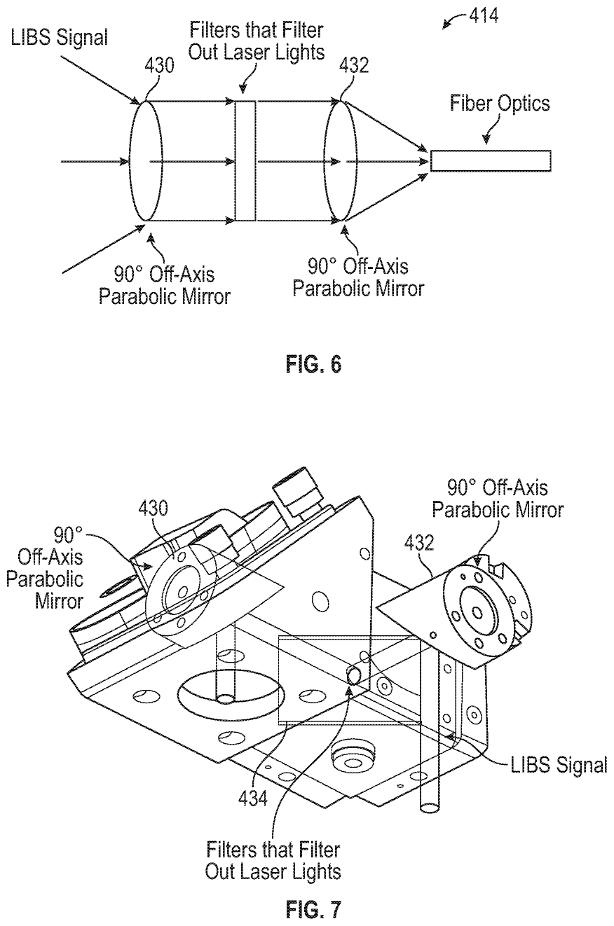

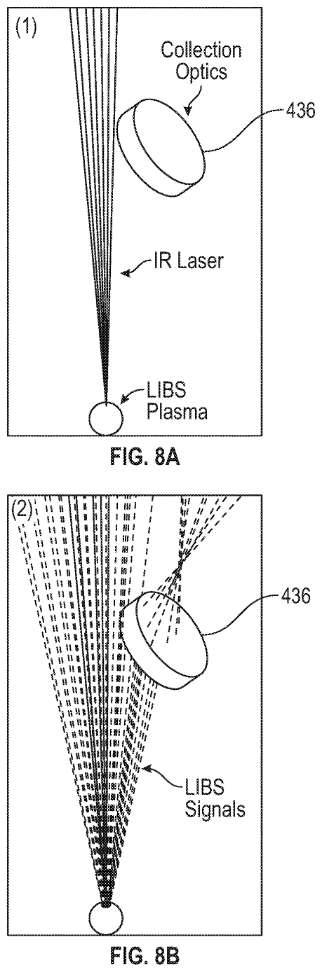

Referring now to FIG. 6, FIG. 7, and FIGS. 8A, 8B, another embodiment of the optical collection system 62, 114, 214. In this embodiment, the optical collection system 414 includes a pair of 90 degree off-axis parabolic mirrors 430, 432 that reflect the LIBS signal away from the sample and into the fiber optic cable. In an embodiment a filter 434 is arranged in the optical pathway between the mirrors 430, 432. The filter 434 is configured to filter light of the wavelength of the pulsed laser beam and reduce the risk of incidental or undesired light from entering the fiber optic cable. It should be appreciated that the LIBS signal emitted by the laser-induced plasma is a diffuse light, it has been found that the embodiment of FIG. 6 and FIG. 7 provides benefits in allowing the use of a larger collimating lens 436 (FIGS. 8A, 8B) to collect the LIBS signal that is then focused into the smaller fiber optic components. In testing it was found that this provided a 250% improvement in the average intensity of the LIBS signal.

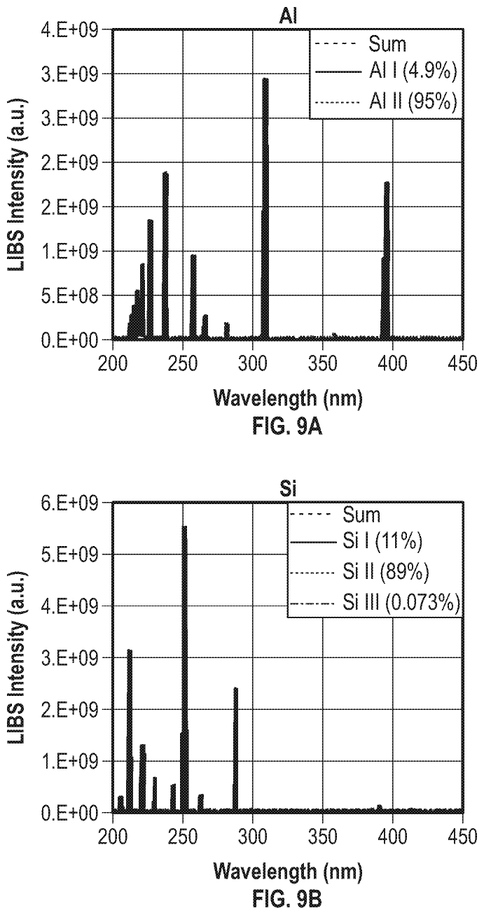

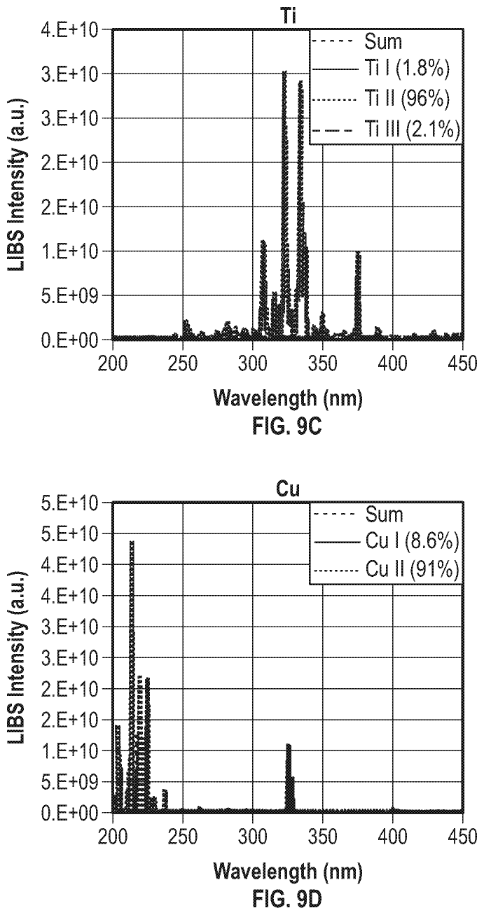

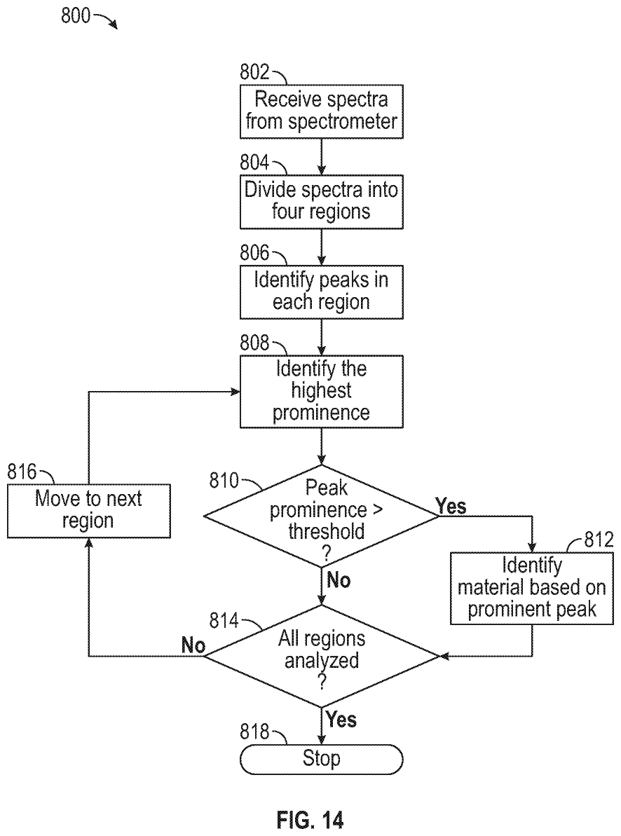

It is known in the art that laser-induced breakdown spectroscopy generates a spectra that is unique for a number of materials. FIGS. 9A-9D illustrate LIBS spectra for four materials, namely Aluminum, Silicon, Titanium, and Copper respectively. Based on this property of LIBS, it is possible to identify a material with a desired level of confidence by comparing a spectra from an acquired LIBS signal with known material spectra. As discussed in more detail herein, in practice it is not as simple to identify the material because the acquires spectra is not as clean as those shown in FIGS. 9A-9D . In an embodiment discussed below with reference to FIG. 14 a method is provided for identifying the material even with spectra that includes noisy data.

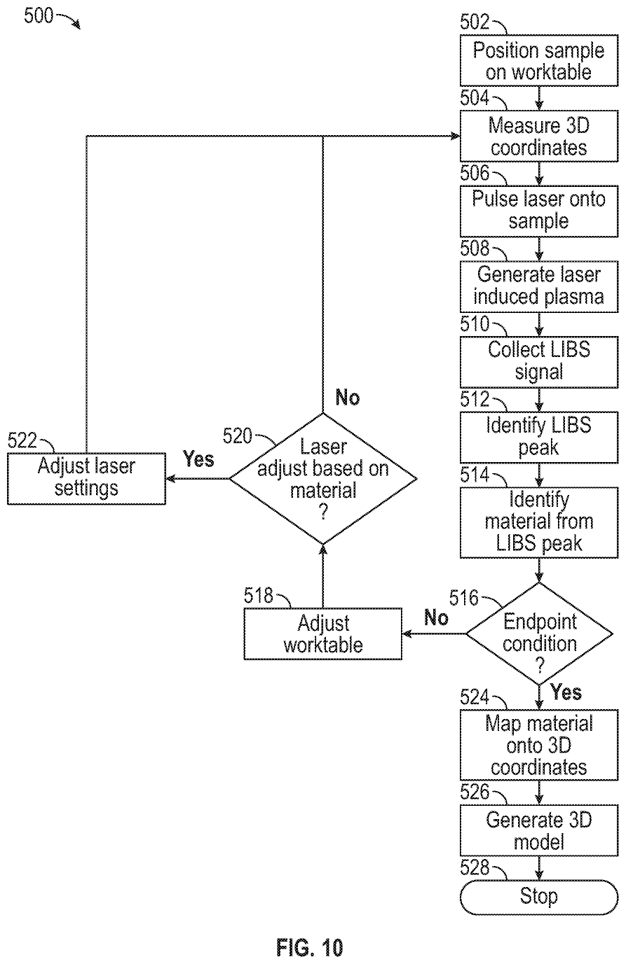

Referring now to FIG. 10, a method 500 is shown for measuring the 3D coordinates of the surface of the object, identifying materials within the object, and generating a unified electronic model of the object that includes both geometric and material parameters. The method 500 begins in block 502 where the object is positioned on the worktable. The method 500 then proceeds to block 504 where the 3D coordinates of the surface of the object (or the layer of the object) are obtained using the 3D measurement system. The method 500 then proceeds to block 506 where pulses of the laser light beam are emitted onto the object being analyzed. The laser light creates a plasma plume on the surface of the object in block 508 as the material is ablated. This laser induced plasma plume emits a LIBS signal that is collected in block 510. The LIBS signal is transferred to the spectrometer that generates a spectrum of the LIBS signal and transfers the spectrum to the system controller.

The method 500 then proceeds to block 512 where the LIBS peaks are identified. As discussed in more detail herein with reference to FIG. 14, in an embodiment, the spectra may be divided into a plurality of areas or regions that are separated analyzed for peaks and only peaks meeting the desired criteria are used in the analysis. With the LIBS peaks identified, the material is identified in block 514.

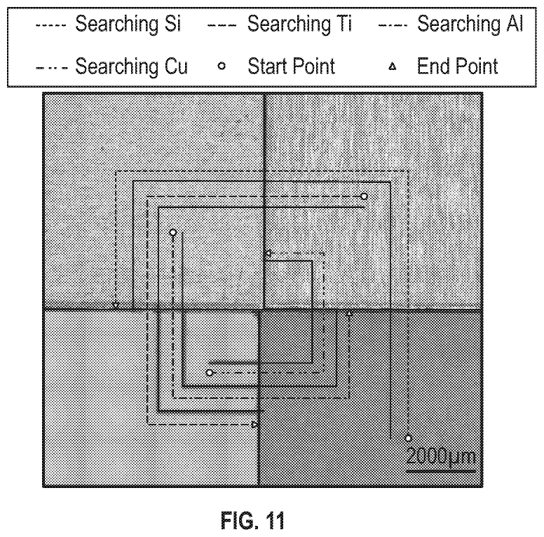

The method 500 then proceeds to query block 516 where it is determined if an endpoint condition has been achieved. Laser endpoint conditions can be implemented in several ways. In each of the embodiments, the laser beam is scanned over the object in a predetermined pattern with the LIBS spectra constantly monitored. The laser ablation is stopped with a predefined condition is satisfied. The end point condition may be triggered upon detection of a predetermined material, or a lack/change of material. In other embodiments, the end point condition may be based on time or a position of the object/worktable for example. An example of endpoint conditions is shown in FIG. 11.

When query block 516 returns a negative (endpoint condition not met), the method 500 proceeds to block 518 where the work table is adjusted to a new or the next position (e.g. movement along the x-axis or y-axis). The method 500 then proceeds to query block 520 where it is determined if the laser needs to be adjusted based on the material identified in block 514. When the query block 520 returns a positive, the method 500 moves to block 522 where the laser settings are adjusted. When the query block 520 returns a negative, or after the laser settings are adjusted in block 522, the method loops back to block 504 and the method repeats until the end point condition is satisfied in query block 516.

When query block 516 returns a positive (endpoint condition satisfied), the method 500 then proceeds to block 524 where the identified material compositions are mapped or associated with the measured 3D coordinates of the object. In an embodiment, the material compositions are also mapped or associated with measured 2D coordinates of the object. The method 500 then proceeds to block 526 where the 3D model of the object is generated with both geometric and material information and the method 500 stops in block 528.

It should be appreciated that while the method 500 is shown as a sequence of steps in a particular order, this is for example purposes and the claims should not be so limited. In other embodiments some of the steps of method 500 may be performed in a different order or may be performed simultaneously with each other.

An example of an analysis of a printed circuit board 600 (PCB) is shown in reference to FIG. 12A nd FIG. 12B. In this embodiment, the PCB 600 includes a body 602 having a plurality of copper traces 604, 606, 608. The lines 610 represent a plurality of laser ablation passes with the system 100. It should be appreciated that as the laser moves over copper traces, the system 100 will determine the material and associate that material with the location of the laser at that point in time. This information is then combined with the 3D measurements and a 3D model 614 may be generated. The copper traces 604, 606 are represented by the lines 616, 618. One of the laser ablation passes 612 extended over to the third copper trace 608. This is represented by the single pixel block 620.

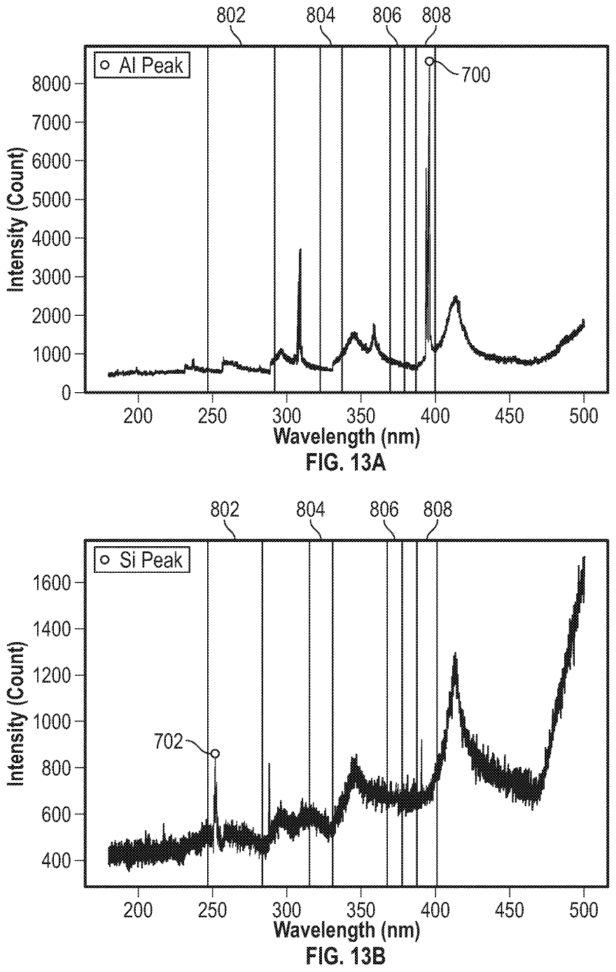

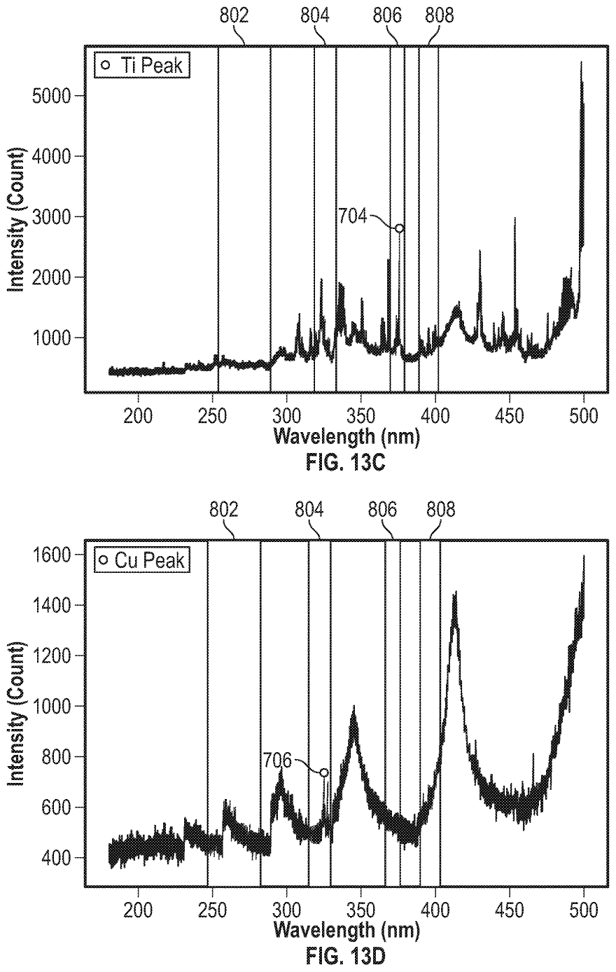

As discussed above, the spectra created from the LIBS signal generated during the method 500 is not as clear as the calculated LIBS spectra. As shown in FIGS. 13A-13D, example spectra generated by the system 100 are shown. As can be seen from FIGS. 13A-13D the spectra include a plurality of peaks over a wide range of wavelengths. The peaks indicated by the circles 700, 702, 704, 706 represent the identifying peaks for Aluminum, Silicon, Titanium and Copper respectively.

To filter out the noise and increase the reliability of the material identification, a method 800 is shown for identifying the desired peaks. The method 800 begins in block 802 where the spectra (e.g. the spectra of FIGS. 13A-13D) are received. In block 804, the spectra is divided into four intervals or regions 803, 805, 807, 809 corresponding to the regions of the four materials that are expected to be in the object. It should be appreciated that in other embodiments, other materials may be included other than aluminum, silicon, titanium, and copper. In the illustrated embodiment the range for detecting aluminum is 390-400nm, for silicon is 247-292 nm, for titanium is 372-380 nm, and for copper is 320-331 nm. It was found via testing that these ranges provided an accuracy of 99.91%, 99.98%, 100%, and 95.91% for identification of each of the materials respectively.

The method 800 then proceeds to block 806 where each of the peaks in each region are identified and the peak with the highest prominence is identified in block 808. The method 800 then proceeds to query block 810 where the first region is analyzed to determine if the peak of highest prominence is greater than a threshold. When the query block 810 returns a positive (threshold exceeded), the material is identified in block 812. After the material is identified, or when the query block 810 returns a negative, the method 800 proceeds to query block 814 where it is determined if all the regions 803, 805, 807, 809 have been evaluated and the method 800 loops back to block 808. This continues until all of the regions 803, 805, 807, 809 have been evaluated whereupon the query block 814 returns a positive and the method 800 stops in block 818.

It should be appreciated that during operation, it is possible for two materials to be ablated and generate LIBS signals simultaneously. In this situation, there may be multiple peaks identified in multiple regions. This may occur, for example when the laser beam, which has a diameter, starts to cross from a first material to a second material. Depending on the feed rate of the laser and the size of the laser beam, there may be multiple measurements where two or more different materials return LIBS signals. In an embodiment, when multiple peaks are detected, both materials are stored. In an embodiment, the signal intensities of the respective peaks are compared against the expected intensity and the percentage of each material may be determined. For example, as the laser moves from silicon into copper, the percentage of copper will be small relative to the silicon. However, as the laser continues to move into the copper material that ratio will change until the silicon disappears. In some embodiments, this ratio of the materials can be used to obtain a sub-pixel resolution on the location of the materials.

Embodiments of the present disclosure provide for a technical effect that allows for analysis of objects or samples to simultaneously, and in real-time, generates a 3D electronic model of the object that includes both geometric and material characteristics/properties of the object.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It should also be noted that the terms “first”, “second”, “third”, “upper”, “lower”, and the like may be used herein to modify various elements. These modifiers do not imply a spatial, sequential, or hierarchical order to the modified elements unless specifically stated.

Various embodiments of the invention are described herein with refer25ence to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A system comprising:
a laser machining device configured to emit a pulsed laser light onto an object and generate a laser induced plasma;
a material characterization device configured to receive an optical signal from the laser induced plasma and outputting a material signal in response;
a three-dimensional (3D) measurement device configured to measure coordinates of a surface of the object; and
a computation system having at least one processor, the computation system being operably coupled to the laser machining device, the material characterization device and the 3D measurement device, the computation system being responsive to executable computer instructions to receiving the material signal, identifying a material of the object, and in response to the identifying the material of the object causing a change of at least one parameter of the laser light.

2. The system of claim 1, wherein the computation system is further responsive to executable computer instructions to generate a three-dimensional model of the object based at least in part on the 3D measurement device and the identified material.

3. The system of claim 2, wherein the computation system is further responsive to executable instructions to associate the identified material with one or more 3D coordinates or one or more two-dimensional (2D) coordinates.

4. The system of claim 3, wherein the computation system is further responsive to executable instructions to generate a 3D material composition map or a 2D material composition map of the object based at least in part on the association of the identified material with one or more 3D coordinates.

5. The system of claim 1, wherein the laser machining device is configured to generate two pulses separated by 20 nano-seconds with a repetition rate of 30-100 kHz, with a fluence of about 13-20 J/cm\hat{ }2.

6. The system of claim 1, wherein the laser machining device is configured to emit the laser light with a wavelength of 1035-1064 nm with a power of 30-40 Watts.

7. The system of claim 1, wherein the laser machining device includes a lens system disposed between a light source and the object, the lens system changing a spot size of the laser light.

8. The system of claim 1, wherein the material characterization device includes a receiver having a collimating lens and an optical fiber, the collimating lens being disposed adjacent the object and on an angle relative to the laser light.

9. The system of claim 8, wherein the angle is about 20 degrees relative to the laser light.

10. The system of claim 8, wherein the material characterization device further includes an Echelle spectrometer having a light sensitive sensor, the optical fiber being operably coupled to transfer the optical signal to the light sensitive sensor.

11. The system of claim 1, wherein measurement signal includes a plurality of spectral peaks over a range of wavelengths of light.

12. The system of claim 11, wherein the computation system is further responsive to executable computer instructions to search four predetermined wavelength ranges for spectral peaks, the identifying of the material being based on the finding of a spectral peak.

13. The system of claim 12, wherein the computation system is further responsive to executable computer instructions to select a first spectral peak from a first plurality of spectral peaks in one of the predetermined wavelength ranges, the first spectral peak having a highest prominence of the first plurality of spectral peaks.

14. The system of claim 13, wherein the computation system is further responsive to executable computer instructions to discard the first spectral peak when the prominence of the first spectral peak is less than a threshold.

15. The system of claim 12, wherein the computation system is further responsive to executable computer instructions to cause the laser machining device to stop emitting the laser light in response to determining the material is a predetermined material.

16. The system of claim 1, further comprising a dichromic mirror disposed between the laser machining device and the sample, the dichromic mirror being configured to emit the laser light to pass from the laser machining device to the object and to reflect a second light emitted by the 3D measurement device.

17. The system of claim 16, wherein the 3D measurement device is a confocal microscope and the second light is a confocal microscope beam.

18. The system of claim 16, wherein the 3D measurement device is selected from a group comprising a structured light scanner, a laser line probe, a time-of-flight scanner, a photogrammetry device, an RGB-D camera, and a LIDAR scanner.

19. A method comprising:
measuring 3D coordinates of an object;
pulsing a laser light onto the object generating a laser induced plasma;
receiving a LIBS signal;
identifying at least one peak in the LIBS signal;
identifying a material from the at least one peak; and
changing of at least one parameter of the laser light based at least in part on the identified material.

20. The method of claim 19, further comprising:
associating the identified material with a measured 3D coordinate; and
generating a 3D or a 2D material composition map of the object based at least in part on the associating of the identified material with the measured 3D coordinate.
